(19) United States
(12) Patent Application Publication
(10) Pub. No.: US 2024/0332566 A1
(43) Pub. Date: Oct. 3, 2024

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/599,747

(22) Filed: Mar. 8, 2024

Related U.S. Application Data
(63) Continuation of application No. PCT/JP2023/013170, filed on Mar. 30, 2023.

(51) Int. Cl. H01M 8/04119; H01M 8/0228; H01M 8/0256

(52) U.S. Cl. CPC H01M 8/04149; H01M 8/0228; H01M 8/0256

(57) ABSTRACT

An electrochemical cell includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. In a plan view of the principal surface, at least a portion of an outer edge of the gas diffusion layer has a wave shape in which a peak portion and a valley portion are alternately continuous with each other.

### CROSS-REFERENCE TO RELATED APPLICATION

This is a continuation of PCT/JP2023/013170, filed on Mar. 30, 2023, the entire contents of which are hereby incorporated by reference.

### TECHNICAL FIELD

The present invention relates to an electrochemical cell.

### BACKGROUND ART

Electrochemical cells (electrolytic cells, fuel cells etc.) are conventionally known that have a cell body disposed on a metal substrate. The metal substrate has a plurality of connecting holes, which are formed in a principal surface thereof. The cell body is formed on the principal surface of the metal substrate and has a first electrode layer that covers the plurality of connecting holes, a second electrode layer, and an electrolyte layer disposed between the first electrode layer and the second electrode layer.

Here, WO 2021/221052 describes interposing an electrically conductive gas diffusion layer between a cell body and a metal substrate.

### SUMMARY

However, in the electrochemical cell described in Patent Document 1, there is concern that the gas diffusion layer may be separated by stress that occurs between the metal substrate and the gas diffusion layer due to a difference in thermal expansion coefficients between the metal substrate and the cell body.

An object of the present invention is to provide an electrochemical cell capable of preventing separation of a gas diffusion layer.

An electrochemical cell according to a first aspect of the present invention includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. In a plan view of the principal surface, at least a portion of an outer edge of the gas diffusion layer has a wave shape in which a peak portion and a valley portion are alternately continuous with each other.

An electrochemical cell according to a second aspect of the present invention is the electrochemical cell of the first aspect, wherein in the plan view of the principal surface, the peak portion protrudes to form a curved shape in a direction away from the plurality of connecting holes, and in the plan view of the principal surface, the valley portion is recessed to form a curved shape in a direction approaching the plurality of connecting holes.

An electrochemical cell according to a third aspect of the present invention is the electrochemical cell of the second aspect, wherein in the plan view of the principal surface, a first perpendicular intersects an outermost connecting hole located at an outermost end in a surface direction, of the plurality of connecting holes, the first perpendicular being perpendicular to a first tangent and passing through a valley bottom point of the valley portion, the first tangent being tangent to the valley bottom point, and in the plan view of the principal surface, a second perpendicular does not intersect the outermost connecting hole, the second perpendicular being perpendicular to a second tangent and passing through a vertex of the peak portion, and the second tangent being tangent to the vertex.

An electrochemical cell according to a fourth aspect of the present invention is the electrochemical cell of the third aspect, wherein in the plan view of the principal surface, the second perpendicular intersects an inner connecting hole arranged inward of the outermost connecting hole by one level, of the plurality of connecting holes.

According to the present invention, it is possible to provide an electrochemical cell capable of preventing separation of a gas diffusion layer.

### BRIEF DESCRIPTION OF DRAWINGS

FIG. 1 is a plan view of an electrolytic cell according to an embodiment.

FIG. 2 shows an A-A cross-section of FIG. 1.

FIG. 3 is a plan view of an electrolytic cell according to the embodiment from which a hydrogen electrode layer, an electrolyte layer, a reaction-preventing layer, and an oxygen electrode layer are removed.

FIG. 4 is a partial enlarged view of FIG. 3.

### DESCRIPTION OF EMBODIMENTS

Electrolytic cell 1

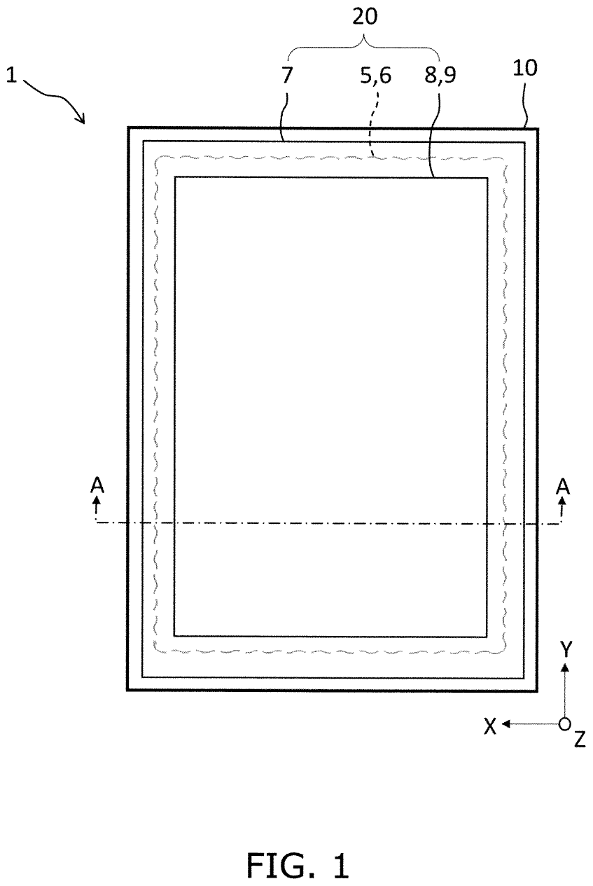

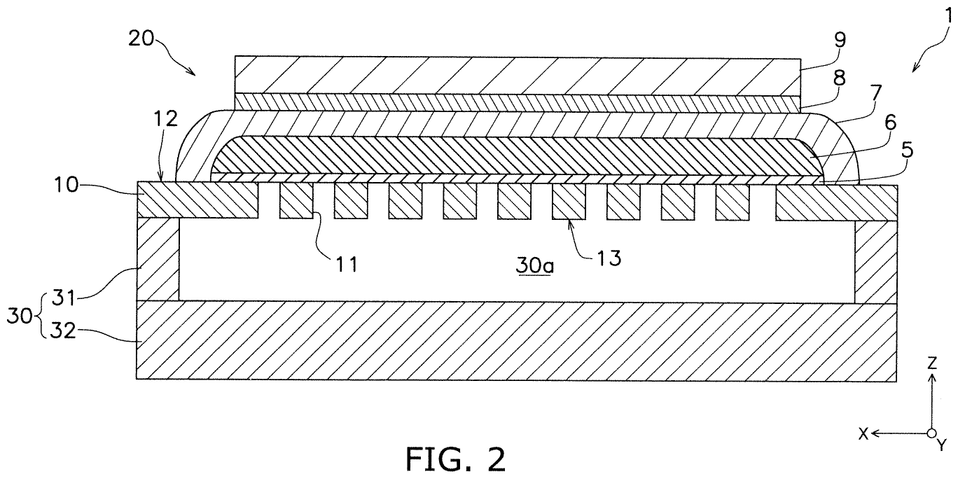

FIG. 1 is a plan view of an electrolytic cell 1 according to an embodiment. FIG. 2 shows an A-A cross-section of FIG. 1.

The electrolytic cell 1 is an example of an “electrochemical cell” according to the present invention. The electrolytic cell 1 is a so-called metal-supported electrolytic cell.

The electrolytic cell 1 has a plate shape expanding in an X-axis direction and a Y-axis direction. The electrolytic cell 1 in the present embodiment has a rectangular shape elongated in the Y-axis direction in a plan view from a Z-axis direction perpendicular to the X-axis direction and the Y-axis direction. However, the shape of the electrolytic cell 1 in the plan view is not specifically limited, and may alternatively be other than a rectangular shape, and may be a polygonal shape, an elliptic shape, a circular shape, or the like.

As shown in FIG. 2, the electrolytic cell 1 includes a metal substrate 10, a cell body 20, and a channel member 30. Metal substrate 10

The metal substrate 10 supports the cell body 20. The metal substrate 10 has a plate shape. The metal substrate 10 may have a flat plate shape or a curved plate shape.

The metal substrate 10 need only be capable of supporting the cell body 20. The thickness of the metal substrate 10 is not specifically limited, but may be, for example, 0.1 mm or more and 2.0 mm or less.

As shown in FIG. 2, the metal substrate 10 has a plurality of connecting holes 11, a first principal surface 12, and a second principal surface 13.

Each connecting hole 11 extends through the metal substrate 10 from the first principal surface 12 to the second principal surface 13. Each connecting hole 11 is open in the first principal surface 12 and the second principal surface 13. In the present embodiment, the opening of each connecting hole 11 in the first principal surface 12 is covered by a later-described gas diffusion layer 5. The opening of each connecting hole 11 in the second principal surface 13 is continuous with a later-described channel 30a.

The connecting holes 11 can be formed by means of mechanical processing (e.g. punching), laser processing, chemical processing (e.g. etching), or the like.

Each connecting hole 11 in the present embodiment has a straight shape extending along the Z-axis direction. However, each connecting hole 11 may be inclined relative to the Z-axis direction, and need not necessarily has a straight shape. The connecting holes 11 may be continuous with each other.

The first principal surface 12 is an example of a “principal surface” according to the present invention. The first principal surface 12 is provided on the opposite side to the second principal surface 13. The cell body 20 is disposed on the first principal surface 12. The channel member 30 is joined to the second principal surface 13.

The metal substrate 10 is made of a metallic material. The metal substrate 10 is, for example, made of an alloy material containing Cr (chromium). Examples of such metallic materials include Fe—Cr alloy steel (stainless steel etc.) and Ni—Cr alloy steel. The content of Cr in the metal substrate 10 is not specifically limited, but can be 4% by mass or more and 30% by mass or less.

The metal substrate 10 may also contain Ti (titanium) and/or Zr (zirconium). The content of Ti in the metal substrate 10 is not specifically limited, but can be 0.01 mol % or more and 1.0 mol % or less. The content of Al in the metal substrate 10 is not specifically limited, but can be 0.01 mol % or more and 0.4 mol % or less. The metal substrate 10 may contain Ti in the form of TiO₂ (titania) and may contain Zr in the form of Zro₂ (zirconia).

The metal substrate 10 may have, on a surface thereof, an oxide film formed by oxidation of constituent elements of the metal substrate 10. A typical oxide film is, for example, a chromium oxide film. The chromium oxide film covers at least a portion of the surface of the metal substrate 10. The chromium oxide film may also cover at least a portion of an inner wall surface of each connecting hole 11.

### Cell Body 20

The cell body 20 is disposed on the metal substrate 10. The cell body 20 is supported by the metal substrate 10. The cell body 20 has a gas diffusion layer 5, a hydrogen electrode layer 6 (cathode), an electrolyte layer 7, a reaction-preventing layer 8, and an oxygen electrode layer 9 (anode).

The gas diffusion layer 5, the hydrogen electrode layer 6, the electrolyte layer 7, the reaction-preventing layer 8, and the oxygen electrode layer 9 are stacked in this order from the metal substrate 10 side in the Z-axis direction. The gas diffusion layer 5, the hydrogen electrode layer 6, the electrolyte layer 7, and the oxygen electrode layer 9 are essential components, and the reaction-preventing layer 8 is an optional component.

### Gas Diffusion Layer 5

The gas diffusion layer 5 is formed on the first principal surface 12 of the metal substrate 10. The gas diffusion layer 5 is interposed between the metal substrate 10 and the hydrogen electrode layer 6. The gas diffusion layer 5 in the present embodiment covers the connecting holes 11 in the metal substrate 10. The gas diffusion layer 5 may be partially located within the connecting holes 11 of the metal substrate 10.

The gas diffusion layer 5 is an electrically conductive porous body having gas diffusion properties. The gas diffusion layer 5 supplies a source gas supplied from the connecting holes 11 to the hydrogen electrode layer 6, and discharges a gas produced in the hydrogen electrode layer 6 through the connecting holes 11.

The gas diffusion layer 5 contains an electrically conductive material. The electrically conductive material may be a metallic material, such as Ni (nickel) or Fe (iron), or an electrically conductive ceramic material.

The gas diffusion layer 5 may also contain a base material that supports the electrically conductive material. The base material may be insulating. The base material can be YSZ, CSZ, ScSZ, GDC, SDC, (La, Sr) (Cr, Mn)O₃, (La, Sr) TiO₃, Sr₂(Fe, Mo)₂O₆, (La, Sr) VO₃, (La, Sr) FeO₃, LDC (lanthanum-doped ceria), LSGM (lanthanum gallate), or a mixed material of two or more of these materials.

The gas diffusion layer 5 may contain a metallic element contained in the metal substrate 10. This brings the gas diffusion layer 5 and the metal substrate 10 into more intimate contact and is therefore preferable. Note that the aforementioned electrically conductive material is different from the metallic element contained in the metal substrate 10. Accordingly, the electrically conductive material contained in the gas diffusion layer 5 need not be contained in the metal substrate 10.

The porosity of the gas diffusion layer 5 is not specifically limited, but can be, for example, 20% or more and 40% or less.

The porosity of the gas diffusion layer 5 is calculated by the following method. First, a cross section of the gas diffusion layer 5 along the Z-axis direction is exposed. Next, using a SEM device (FE-SEM JSM-7900F, manufactured by JEOL Ltd.), a backscattered electron image of the cross section of the gas diffusion layer 5 is acquired at a magnification of 10000 times. Next, portions displayed in black (which correspond to pores) in the backscattered electron image are identified using image analysis software Image-Pro, manufactured by MEDIACYBERNETICS. Then, the porosity of the gas diffusion layer 5 is calculated by dividing the total area of the pores by the total area of the backscattered electron image of the gas diffusion layer 5.

The thickness of the gas diffusion layer 5 is not specifically limited, but can be, for example, 1 μm or more and 50 μm or less. The term “thickness” as used herein means the thickness in the thickness direction of the cell body 20. The term “thickness direction” refers to a direction perpendicular to a surface direction parallel to the first principal surface 12 of the metal substrate 10. The thickness direction is identified by using an approximate straight line of the first principal surface 12 that is obtained by the least squares method in a cross section of the metal substrate 10 along the Z-axis direction.

The method of forming the gas diffusion layer 5 is not specifically limited, and can be a sintering method, a spray coating method (thermal spray method, aerosol deposition method, aerosol gas deposition method, powder jet deposition method, particle jet deposition method, cold spray method etc.), a PVD method (sputtering method, pulsed laser deposition method etc.), a CVD method, or the like.

### Hydrogen Electrode Layer 6

The hydrogen electrode layer 6 is an example of a “first electrode layer” according to the present invention. The hydrogen electrode layer 6 is formed on the gas diffusion layer 5. The hydrogen electrode layer 6 is disposed between the gas diffusion layer 5 and the electrolyte layer 7.

The source gas is supplied to the hydrogen electrode layer 6 from the connecting holes 11 via the gas diffusion layer 5. The source gas contains at least H₂O.

When the source gas contains only H₂O, the hydrogen electrode layer 6 produces H₂ from the source gas in accordance with the electrochemical reaction of water electrolysis expressed by the following chemical equation (1).

Hydrogen electrode layer6:H₂O+2e⁻→H₂+O²⁻ (1)

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

Hydrogen electrode layer6:CO₂+H₂O+4e−→CO+H₂+2O²⁻ (2)

Electrochemical reaction of H₂O:H₂O+2e⁻→H₂+O²⁻ (3)

Electrochemical reaction of CO₂:CO₂+2e⁻→CO+O²⁻ (4)

The hydrogen electrode layer 6 is an electrically conductive porous body having gas diffusion properties. The source gas is supplied to the hydrogen electrode layer 6 from the gas diffusion layer 5. A gas produced in the hydrogen electrode layer 6 is discharged toward the gas diffusion layer 5.

The hydrogen electrode layer 6 contains an electrically conductive material. The electrically conductive material may be a metallic material, such as Ni (nickel) or Fe (iron), or an electrically conductive ceramic material. In the case of co-electrolysis, Ni also functions as a thermal catalyst to promote the thermal reaction between H₂ produced and CO₂ contained in the source gas and maintain a gas composition appropriate for methanation, reverse water-gas shift reactions, or the like.

The electrically conductive material exists in an oxide state (e.g. NiO) in an oxidizing atmosphere, and exists in a metallic state (e.g. Ni) in a reducing atmosphere. The present embodiment envisions that the electrolytic cell 1 is exposed to a reducing atmosphere.

The hydrogen electrode layer 6 contains an oxide ion-conductive material. The oxide ion-conductive material can be YSZ, CSZ, ScSZ, GDC, SDC, (La, Sr) (Cr, Mn) O₃, (La, Sr)TiO₃, Sr₂ (Fe, Mo)₂O₆, (La, Sr)VO₃, (La, Sr)FeO₃, LDC, LSGM, or a mixed material of two or more of these materials.

In the present embodiment, the hydrogen electrode layer 6 has a single layer structure constituted by a single composition, but may alternatively have a multilayer structure constituted by different compositions.

The porosity of the hydrogen electrode layer 6 is not specifically limited, but can be, for example, 20% or more and 40% or less. The porosity of the hydrogen electrode layer 6 is calculated by dividing the total area of pores by the total area of the backscattered electron image of the hydrogen electrode layer 6, similarly to the aforementioned porosity of the gas diffusion layer 5.

The thickness of the hydrogen electrode layer 6 is not specifically limited, but can be, for example, 1 μm or more and 500 μm or less.

The method of forming the hydrogen electrode layer 6 is not specifically limited, and can be a sintering method, a spray coating method, a PVD method, a CVD method, or the like.

Electrolyte layer 7

The electrolyte layer 7 is disposed between the hydrogen electrode layer 6 and the oxygen electrode layer 9. In the present embodiment, the reaction-preventing layer 8 is disposed between the electrolyte layer 7 and the oxygen electrode layer 9, and the electrolyte layer 7 is therefore sandwiched between the hydrogen electrode layer 6 and the reaction-preventing layer 8.

The electrolyte layer 7 covers the hydrogen electrode layer 6 and also covers a region of the first principal surface 12 of the metal substrate 10 that is exposed from the gas diffusion layer 5.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g. 8YSZ), GDC (gadolinium doped ceria), ScSZ (scandia stabilized zirconia), SDC (samarium solid solution ceria), LSGM (lanthanum gallate), or the like.

The porosity of the electrolyte layer 7 is not specifically limited, but can be, for example, 0.1% or more and 7% or less. The thickness of the electrolyte layer 7 is not specifically limited, but can be, for example, 1 μm or more and 100 μm or less.

The method of forming the electrolyte layer 7 is not specifically limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on the opposite side to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is constituted by an oxide ion-conductive material. The reaction-preventing layer 8 can be made of GDC, SDC, or the like.

The porosity of the reaction-preventing layer 8 is not specifically limited, but can be, for example, 0.1% or more and 50% or less. The thickness of the reaction-preventing layer 8 is not specifically limited, but can be, for example, 1 μm or more and 50 μm or less.

The method of forming the reaction-preventing layer 8 is not specifically limited, and can be a sintering method, a spray coating method, a PVD method, a CVD method, or the like.

### Oxygen Electrode Layer 9

The oxygen electrode layer 9 is an example of a “second electrode layer” according to the present invention. The oxygen electrode layer 9 is disposed on the opposite side to the hydrogen electrode layer 6 with respect to the electrolyte layer 7. In the present embodiment, the reaction-preventing layer 8 is disposed between the electrolyte layer 7 and the oxygen electrode layer 9, and the oxygen electrode layer 9 is therefore connected to the reaction-preventing layer 8. If the reaction-preventing layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transmitted from the hydrogen electrode layer 6 via the electrolyte layer 7, in accordance with the chemical reaction expressed by the following chemical equation (5).

Oxygen electrode layer9:2O²⁻→O₂+4e⁻ (5)

The oxygen electrode layer 9 is an oxide ion-conductive and electrically conductive porous body. The oxygen electrode layer 9 can be made of, for example, a composite material of an oxide ion-conductive material (GDC etc.) and at least one of (La, Sr) (Co, Fe)O₃, (La, Sr) FeO₃, La(Ni, Fe)O₃, (La, Sr)CoO₃, and (Sm, Sr)COO₃.

The porosity of the oxygen electrode layer 9 is not specifically limited, but can be, for example, 20% or more and 60% or less. The thickness of the oxygen electrode layer 9 is not specifically limited, but can be, for example, 1 μm or more and 100 μm or less.

The method of forming the oxygen electrode layer 9 is not specifically limited, and can be a sintering method, a spray coating method, a PVD method, a CVD method, or the like.

### Channel Member 30

The channel member 30 is joined to the second principal surface 13 of the metal substrate 10. The channel member 30 forms a channel 30a between the channel member 30 and the metal substrate 10. The source gas is supplied to the channel 30a. The source gas supplied to the channel 30a is supplied to the hydrogen electrode layer 6 of the cell body 20 via the connecting holes 11 in the metal substrate 10.

The channel member 30 can be made of an alloy material, for example. The channel member 30 may be made of the same material as the metal substrate 10. In this case, the channel member 30 may be substantially integrated with the metal substrate 10.

The channel member 30 has a frame 31 and an interconnector 32. The frame 31 is an annular member that surrounds the sides of the channel 30a. The frame 31 is joined to the second principal surface 13 of the metal substrate 10. The interconnector 32 is a plate-shaped member for electrically connecting an external power source or another electrolytic cell to the electrolytic cell 1 in series. The interconnector 32 is joined to the frame 31.

The frame 31 and interconnector 32 in the present embodiment are separate members, but the frame 31 and interconnector 32 may alternatively be an integrated member.

### Shape of Gas Diffusion Layer 5 in Plan View

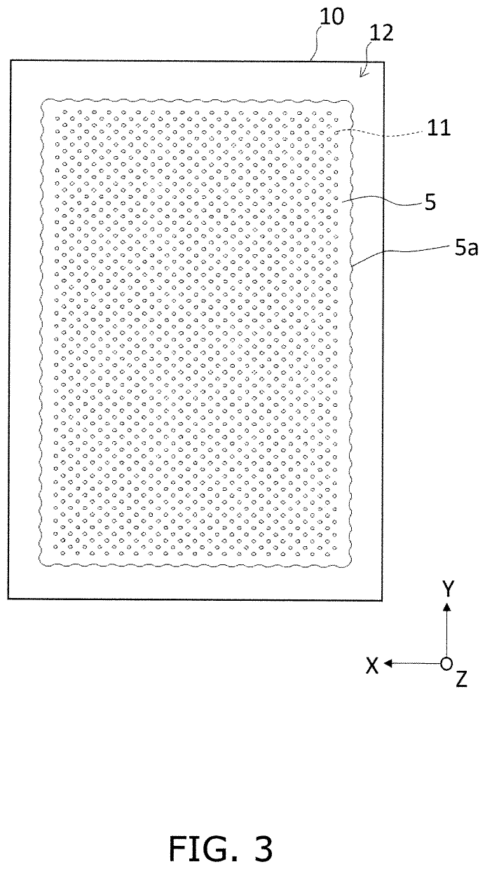

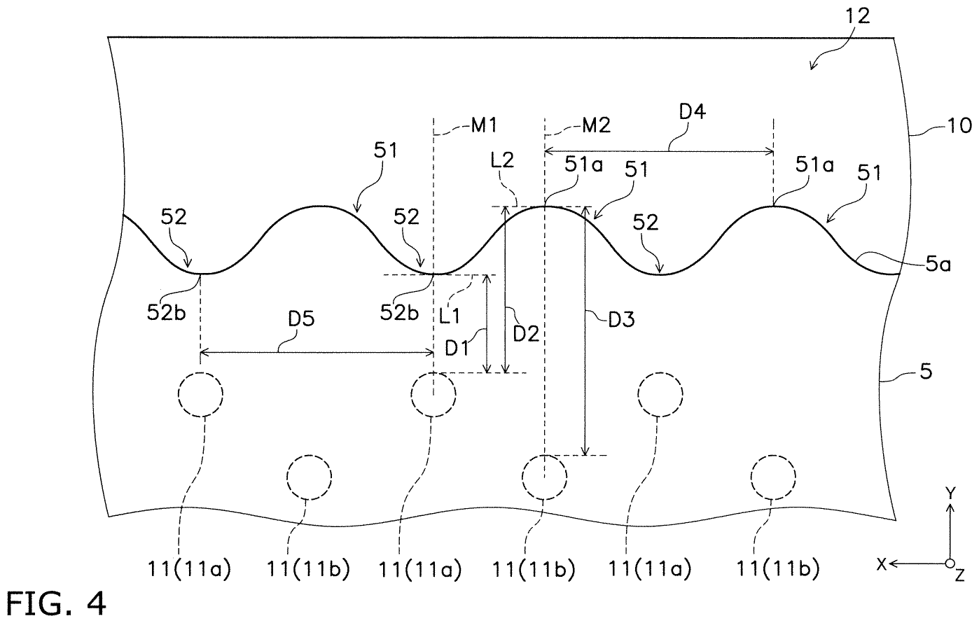

FIG. 3 is a plan view of the electrolytic cell 1 from which the hydrogen electrode layer 6, the electrolyte layer 7, the reaction-preventing layer 8, and the oxygen electrode layer 9 of the cell body 20 are removed. FIG. 4 is a partial enlarged view of FIG. 3.

As shown in FIG. 3, the gas diffusion layer 5 covers the plurality of connecting holes 11 in the metal substrate 10 in a plan view of the first principal surface 12 of the cell body 20. Although the shape of the gas diffusion layer 5 in a plan view is a rectangular shape as a whole in the present embodiment, this need not be the case. The shape of the gas diffusion layer 5 in a plan view can be changed as appropriate while giving consideration to the shape of the cell body 20 in a plan view and the shape of the region where the plurality of the connecting holes 11 are formed in a plan view.

As shown in FIG. 4, the plurality of connecting holes 11 in the metal substrate 10 are arranged in a staggered grid. This can easily increase the density of the connecting holes 11. However, the arrangement of the connecting holes 11 can be changed as appropriate.

In a plan view of the first principal surface 12, an outer edge 5a of the gas diffusion layer 5 has a wave shape with peak portions 51 and valley portions 52 alternately continuous with each other, as shown in FIG. 4. With this, when stress occurs between the metal substrate 10 and the gas diffusion layer 5 due to a difference in thermal expansion coefficient between the metal substrate 10 and the cell body 20, the stress applied to the outer edge 5a can be dispersed in the surface direction. Further, the total length of the outer edge 5a can be made longer than in the case of the outer edge 5a having a straight-line shape. As a result, the stress applied to the outer edge 5a can be reduced, and it is therefore possible to prevent the gas diffusion layer 5 from separating from the metal substrate 10.

Note that the entire outer edge 5a in the present embodiment has a wave shape as shown in FIG. 3, but at least a portion of the outer edge 5a of the gas diffusion layer 5 need only have a wave shape. In this case as well, the gas diffusion layer 5 can be prevented from separating from the metal substrate 10 as mentioned above in the wave-shaped region of the outer edge 5a. Accordingly, a portion of the outer edge 5a may have a straight-line shape.

In the present embodiment, each peak portion 51 of the outer edge 5a protrudes to form a curved shape in a direction away from the connecting holes 11, and each valley portion 52 of the outer edge 5a is recessed to form a curved shape in a direction approaching the connecting holes 11, as shown in FIG. 4. That is, the outer edge 5a has a curved wave shape. With this, compared to the case where the outer edge 5a has an angular wave shape (sawtooth shape), the stress applied to the outer edge 5a can be further dispersed in the surface direction, and the total length of the outer edge 5a can be made longer. As a result, the stress applied to the outer edge 5a can be further reduced, and it is therefore possible to further prevent the gas diffusion layer 5 from separating from the metal substrate 10.

Here, the metal substrate 10 includes the plurality of connecting holes 11, and thermal conduction in the surface of the metal substrate 10 is cut off by the connecting holes 11. This makes it more likely that temperature distribution occurs in the metal substrate 10. In addition, during the operation of the electrolytic cell 1, heat absorption and generation occurs from the cell body 20 while heat transfer occurs due to the cell body 20 being heated or dissipating heat. This makes it more likely that temperature distribution occurs at the periphery of the cell body 20. That is, in a plan view of the first principal surface 12, more significant temperature distribution is likely to occur between the inside and outside of the connecting holes 11 arranged at the outermost periphery among the plurality of connecting holes 11 in the metal substrate 10. As a result, the amount of expansion and contraction due to thermal expansion is more likely to vary significantly. Thus, the metal substrate 10 is not isotropically deformed near the connecting holes 11 arranged at the outermost periphery. Accordingly, stress is likely to occur between the metal substrate 10 and a region close to the connecting holes 11 arranged at the outermost periphery of the outer edge 5a of the gas diffusion layer 5. Note that the connecting holes 11 arranged at the outermost periphery are the connecting holes 11 located at the outermost end in the surface direction (X-axis direction or Y-axis direction) among the plurality of connecting holes 11.

In the present embodiment, the positions of the connecting holes 11 arranged at the outermost periphery (hereinafter referred to as “outermost connecting holes 11a”) coincide with the positions of the valley portions 52 in a plan view of the first principal surface 12, as shown in FIG. 4. Specifically, a first perpendicular M1, which is perpendicular to a first tangent L1 tangent to a valley bottom point 52b of each valley portion 52, and which passes through the valley bottom point 52b, intersects an outermost connecting hole 11a. A second perpendicular M2, which is perpendicular to a second tangent L2 tangent to a vertex 51a of the peak portion 51, and which passes through the vertex 51a, does not intersect any outermost connecting hole 11a.

This can bring the outer edge 5a of the gas diffusion layer 5 closer to the outermost connecting holes 11a than in the case where the positions of the outermost connecting holes 11a coincide with the positions of the peak portions 51. Thus, the stress applied to the outer edge 5a due to deformation of the metal substrate 10 near the outermost connecting holes 11a can be further reduced. Accordingly, the gas diffusion layer 5 can be further prevented from separating from the metal substrate 10.

In the present embodiment, the positions of the connecting holes 11 arranged inward of the outermost connecting holes 11a by one level (hereinafter referred to as “inner connecting holes 11b”) coincide with the positions of the peak portions 51 in a plan view of the first principal surface 12, as shown in FIG. 4. Specifically, the second perpendicular M2 passing through the vertex 51a of a peak portion 51 intersects the inner connecting hole 11b. The first perpendicular M1 passing through the valley bottom point 52b of a valley portion 52 does not intersect any inner connecting hole 11b.

Note that the term “inner” of the inner connecting hole 11b means the opposite side to the outer edge 5a with respect to the position of the outermost connecting hole 11a in a direction parallel to the second perpendicular M2.

In a direction parallel to the first perpendicular M1, a distance D1 between the outermost connecting hole 11a and the valley bottom point 52b of the valley portion 52 is shorter than a distance D2 between the outermost connecting hole 11a and the vertex 51a of the peak portion 51. The distance D1 is the shortest distance between the outermost connecting hole 11a and the valley bottom point 52b in the direction parallel to the first perpendicular M1. The distance D2 is the shortest distance between the outermost connecting hole 11a and the vertex 51a in the direction parallel to the first perpendicular M1.

In the direction parallel to the first perpendicular M1, a distance D3 between the inner connecting hole 11b and the vertex 51a of the peak portion 51 is longer than the distance D2 between the outermost connecting hole 11a and the vertex 51a of the peak portion 51. The distance D3 is the shortest distance between the inner connecting hole 11b and the vertex 51a in the direction parallel to the first perpendicular M1.

The value of the distance D1 is not specifically limited, but can be, for example, 0.20 mm or more and 1.0 mm or less. The value of the distance D2 is not specifically limited, but can be, for example, 0.25 mm or more and 2.0 mm or less. The value of the distance D3 is not specifically limited, but can be, for example, 0.50 mm or more and 3.0 mm or less.

The value of a distance D4 between two adjacent vertexes 51a in a direction parallel to the first tangent L1 is not specifically limited, but can be, for example, 0.20 mm or more and 5.0 mm or less.

The value of a distance D5 between two adjacent valley bottom points 52b in the direction parallel to the first tangent L1 is not specifically limited, but can be, for example, 0.20 mm or more and 5.0 mm or less.

### Variations of Embodiment

Although the embodiment of the present invention has been described above, the present invention is not limited thereto, and various changes can be made without departing from the gist of the invention.

### Variation 1

In the present embodiment, the opening of each connecting hole 11 in the metal substrate 10 on the first principal surface 12 side is covered by the gas diffusion layer 5. However, this need not be the case. The gas diffusion layer 5 need not cover the opening of each connecting hole 11 on the first principal surface 12 side. In this case, the gas diffusion layer 5 has through holes connected to the respective connecting holes 11, and the gas can thus be more efficiently supplied and discharged through these through holes.

### Variation 2

In the above embodiment, the hydrogen electrode layer 6 functions as a cathode, and the oxygen electrode layer 9 functions as an anode. However, the arrangement of the hydrogen electrode layer 6 and the oxygen electrode layer 9 may be reversed.

### Variation 3

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal substrate
11 Connecting hole
12 First principal surface
13 Second principal surface
20 Cell body
5 Gas diffusion layer
5a Outer edge
51 Peak portion
51a Vertex
52 Valley portion
52b Valley bottom point
6 Hydrogen electrode layer
7 Electrolyte layer
8 Reaction-preventing layer
9 Oxygen electrode layer
30 Channel member
30a Channel
L1 First tangent
M1 First perpendicular
L2 Second tangent
M2 Second perpendicular

1. An electrochemical cell comprising:
a metal substrate having a principal surface and a plurality of connecting holes formed in the principal surface; and
a cell body disposed on the principal surface,
the cell body having:
a gas diffusion layer disposed on the principal surface, the gas diffusion layer being electrically conductive;
a first electrode layer disposed on the gas diffusion layer;
a second electrode layer; and
an electrolyte layer disposed between the first electrode layer and the second electrode layer, wherein
in a plan view of the principal surface, at least a portion of an outer edge of the gas diffusion layer has a wave shape in which a peak portion and a valley portion are alternately continuous with each other.

2. The electrochemical cell according to claim 1, wherein
in the plan view of the principal surface, the peak portion protrudes to form a curved shape in a direction away from the plurality of connecting holes, and
in the plan view of the principal surface, the valley portion is recessed to form a curved shape in a direction approaching the plurality of connecting holes.

3. The electrochemical cell according to claim 2, wherein
in the plan view of the principal surface, a first perpendicular intersects an outermost connecting hole located at an outermost end in a surface direction, of the plurality of connecting holes, the first perpendicular being perpendicular to a first tangent and passing through a valley bottom point of the valley portion, the first tangent being tangent to the valley bottom point, and
in the plan view of the principal surface, a second perpendicular does not intersect the outermost connecting hole, the second perpendicular being perpendicular to a second tangent and passing through a vertex of the peak portion, and the second tangent being tangent to the vertex.

4. The electrochemical cell according to claim 3, wherein
in the plan view of the principal surface, the second perpendicular intersects an inner connecting hole arranged inward of the outermost connecting hole by one level, of the plurality of connecting holes.
